(19) United States
(12) Patent Application Publication
(10) Pub. No.: US 2024/0075715 A1
(43) Pub. Date: Mar. 7, 2024

(54) Oriented Strand Board

(71) Applicant: Norbord Inc., Toronto (CA)

(72) Inventors: Paul Anthony Lollar, Okolona, MS (US); James L. Black, Saltillo, MS (US); Elizabeth Cacchione, Saint-Lambert (CA); Jack Wallingford, Bemidji, MN (US)

(21) Appl. No.: 18/507,909

(22) Filed: Nov. 13, 2023

Related U.S. Application Data
(62) Division of application No. 14/955,726, filed on Dec. 1, 2015, now abandoned.

(51) Int. Cl. B32B 21/04; B32B 7/04; B32B 21/02; B32B 21/13; B32B 21/14

(52) U.S. Cl. CPC B32B 21/042; B32B 7/04; B32B 21/02; B32B 21/13; B32B 21/14; B32B 2250/03; B32B 2260/026; B32B 2260/046; B32B 2307/50; B32B 2307/538; B32B 2307/726; B32B 2307/748; B32B 2607/00

(57) ABSTRACT

An embodiment method can form an oriented strand board panel. A lay-up has a first surface layer, a second surface layer and a core between the first surface layer and the second surface layer. The first surface layer comprises wood strands with a binding resin that comprises phenolic resin without comprising a pMDI resin and the second surface layer is comprising wood strands with a binding resin that comprises pMDI resin without comprising any phenolic resin. The lay-up is located in a press that includes a first platen facing the first surface layer and a second platen facing the second surface layer. The first surface layer contacts the first platen and the second surface layer contacts a screen. The lay-up is pressed and consolidated to form a consolidated panel having a smooth outer surface of the first surface layer and a rough outer surface of the second surface layer.

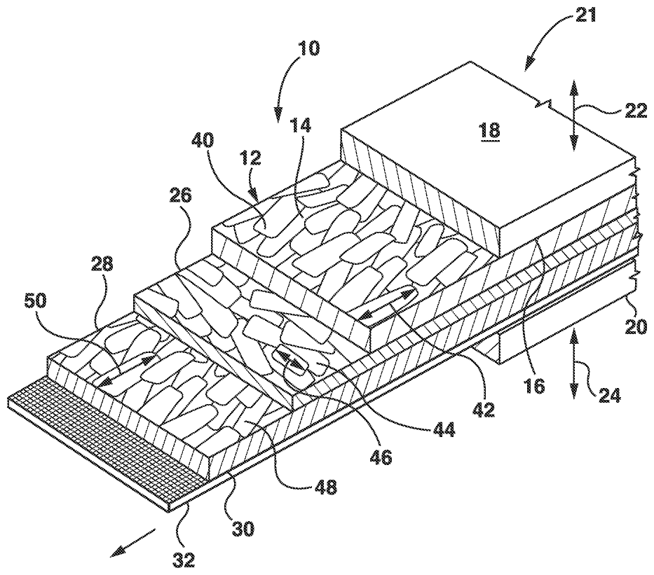

### CROSS-REFERENCE TO RELATED APPLICATIONS

This application is a division of U.S. application Ser. No. 14/955,726, filed on Dec. 1, 2015, which application is hereby incorporated herein by reference.

### TECHNICAL FIELD

The present invention relates to a new oriented strand board (OSB) panel, the making of which substantially reduces the cost of the manufacturing yet produces a panel having the required physical characteristics and similar qualities to those currently available on the market.

### BACKGROUND

Generally (OSB) panels are composed of a smooth surface layer or platen-side layer (first layer) that forms a smooth panel surface and a core made of one or more layers and what will be referred to as a rough or screen side layer (second layer) that forms the second surface i.e. the surface of the panel opposite to the first or smooth surface of the panel. Each of the layers is composed of wood strands (which is intended to include wafers or wood particles) to which resin and generally wax is applied and the panel is formed by laying the layers one on top of the other i.e.one or the other of the first or second layers with the core layer there between to form a lay-up that is then hot pressed to activate the resin and press the layers into a consolidated panel. The strands in the first layer are normally oriented with their longitudinal axes (grain direction) parallel as are the strands in the second layer and the strands in these two layers are also parallel to each other. The strands in the core also normally have their longitudinal axes (grain direction) parallel, but not parallel to the longitudinal axes of the strands in the first and second layers; generally the longitudinal axes of the strands in the core are substantially perpendicular to the longitudinal axes of the strands in the first and second layers.

The balance (tendency to warp, absorb moisture or the like) of the resulting consolidated panel is very important and to produce a panel with acceptable balance it is the practice in the art to make the compositions and the thicknesses of the first (smooth) and second (rough) layers similar and in most cases the same. This problem of balance is discussed for example in Canadian patent 2,097,275 issued May 20, 2003 to Lindquist et al.

One of the preferred resins used to make OSB is polymeric methylene diphenyl diisocyanate (pMDI) which is applied as 100% solids pMDI and is normally used in the core and sometimes in all of the layers of the panel. The use of pMDI in the surface layers requires the application of a significant amount of a release agent to the first or smooth side that contacts the flat metal platen of the press during heated pressing and consolidation of the panel, which adds significantly to the cost, and is required to avoid sticking to the metal.

It is also common to use the same phenolic resin (PF) in the both surface forming layers i.e. in first and second layers defined above to provide a balanced panel. The present invention provides a less expensive alternative with essentially the same performance characteristics.

### SUMMARY

It is an object of the present invention to provide an OSB panel that retains its quality but is significantly less expensive to manufacture.

Broadly the present invention relates to an oriented strand board (OSB) panel having a first surface layer that provides a smooth surface on said panel formed by contacting a press platen during consolidation and a second surface layer that provides a rough surface on said panel due to contact with a screen during consolidation and a core there between, each said layer and said core being composed of wood strands with a binding resin, said binding resin of said first surface layer being significantly different from said binding resin in said second surface layer and said core and having properties such that said binding resin of said first layer does not stick to the platen during pressing.

Preferably the resin in said first layer is a phenolic resin and said resin in said second surface layer is polymeric methylene diphenyl diisocyanate (pMDI)

Preferably the phenolic resin is a phenol formaldehyde resin (PF) and is present in the amount of 1.5 to 6% by weight of said strands.

Preferably the phenolic resin is Melamine urea phenol formaldehyde (map) resin.

Preferably the phenolic resin includes up to 50% Melamine urea phenol formaldehyde (muPF) resin based the weight of the phenolic resin with the remainder of the phenolic resin bphenol formaldehyde (pf) and said phenolic resin is present in the amount of 1.5 to 6% by weight of said strands.

Preferably a polymeric methylene diphenyl diisocyanate (pMDI) resin is present in said second layer is in the range of between 1.2 to 6% based on the weight of said strands in second layer. Preferably each of the first and second layers comprises 15-70 percent of the total weight of said panel.

### BRIEF DESCRIPTION OF THE DRAWINGS

Further features, objects and advantages will be evident from the following detailed description of the preferred embodiments of the present invention taken in conjunction with the accompanying drawings in which:

The sole FIGURE is an isometric illustration of the panel of the present invention showing it leaving the press with the first or smooth surface layer having been pressed in direct contact with a smooth surfaced platen and the second or rough side layer being in position on the wire and with the core there between.

### DETAILED DESCRIPTION OF ILLUSTRATIVE EMBODIMENTS

As shown in the drawing the oriented strand board (OSB) panel 10 of the present invention is composed of a first or smooth layer 12 that provides a smooth surface 14 on the panel 10 formed by contact with the surface 16 of the platen 18 during consolidation in the press 21 between the press platens 18 and 20. As schematically indicated by the arrows 22 and 24 the platens 18 and 20 are relatively moveable between and open position to permit entry of a layup (not shown) from which the panel 10 is made and exit of the consolidated panel 10 and to press and consolidate the panel 10 between entry and exit.

The panel 10 further includes a core 26 that is between the first layer 12 and a second or rough layer 28 provides a rough surface 30 on the panel formed by contact with the screen 32 that, in the illustrated system, delivers a lay-up (not shown) into the press 21 and the consolidated panel 12 from the press 21 after the consolidation step in the press 21. The rough surface 30 is formed by the screen 32 which is between the surface of the platen 20 and the panel 10 during pressing. It will be noted that the strands 40 in the first layer have their longitudinal axes 42 (illustrated by a double ended arrow) substantially parallel as do the strands 44 in the core 26 as indicated by the double arrow 46 and the strands 48 in the second or rough surfaced layer 28 as indicated by the double arrow 50. The orientation of the strands in the core 26 is normally at an angle usually perpendicular to the orientation of the strands in the first and second layers which are normally parallel to each other. In the illustration the core 26 is shown as being composed of a single layer—in some panels the core 26 may be made of a plurality of layers and the orientation of the strands in each of those layers will be parallel but normally at different angles to the orientation of the strand in the first and second layers. The thickness of the surface forming layers 12 and 28 will normally be about equal and will total between 15 and 70 percent of the total weight of the panel 10.

The method and the structure of the OSB panels described above relate to a conventional OSB panel and method of producing an OSB panel. The resin generally accepted as having the best performance to cost ratio is polymeric methylene diphenyl diisocyanate (pMDI) resin and has been used in all layers of the panel or strictly in the core. pMDI resin sticks to metal and a significant amount of release agent is applied to eliminate sticking particularly of the first or smooth layer; however the release agents normally used are either very expensive (silicone based chemistries) or considerably less expensive but highly corrosive resulting in platen corrosion, requiring the platens to be replaced. In the illustrated arrangement when pMDI is the resin in the first surface layer and the platen 18 comes in direct contact with this layer 12 to form the panel surface 14 significant amount of release agent is required which adds significantly to the cost or the platen 18 incurs significant damage compared to platen 20 with the wire 32 between the panel 12 surface 30 and the surface of platen 20 which requires significantly less release agent to free the panel 10. The use of this release agent is a very significant portion of the cost of making these OSB panels with pMDI in both surfaces layers i.e. in the first 12 and second layers 28 with the amount required for layer 12 adding the most to the cost. This increase in cost is most significant when making thin panels. The second or rough surface 30 that contacts the wire 32 when pMDI is the resin used requires significantly less release agent than the first side 14 as the release agent is applied to the wire 32.

The use of phenolic resins in both the first and second layers is common practice in the art as its use avoids the requirement for release agent.

The balance or degree of warping of the panel as discussed below is important and for this reason, it is believed, prior to the present invention the same resin has been used in the first and second layers i.e. both surface layers contain the phenolic resin or if pMDI is used both surface layers 12 and 28 pMDI.

The use of phenolic resins such as PF resins as opposed to pMDI resins as taught herein increases the cost to produce a panel having physical characteristic commercially required in a panel even though the unit cost i.e. per pound cost of pMDI is significantly higher than PF resins the amount of pMDI required to achieve the required characteristics more than compensates for this higher cost.

As above indicated the use of pMDI in the surface layers particularly the first or smooth layer that contacts a press platen directly poses problems in that pMDI sticks to the platen and causes significant problems and requires the use of a release agent which as above indicated adds very significantly to the cost particularly when the release agent is corrosive. Applicant has found that by using a phenolic resin in first or smooth layer 12 and pMDI in the core 26 and second layer 28 of the panel 10 the need for a release agent is eliminated for the smooth layer 12 as there is essentially no risk of sticking to the platen and surprisingly that the balance (degree or warping) of the consolidated panel 10 is not impaired. This change eliminates platen corrosion for platen 18 that contacts the first or smooth side layer 12 and since the requirement for release agent is essentially eliminated on the smooth side 14 of the panel 10 and the requirement is minimal on the screen side (second layer 28) even with pMDI as the resin. Furthermore this change i.e. the use of pMDI instead of PF in the second or screen side layer 28 permits the cost to be reduced relative to panels with PF in both the first and second layers 12 and 28.

To this end if one is starting from a panel with pMDI in both surface layers 12 and 28 Applicant replaces the pMDI resin in the first layer 12 with a phenolic resin while leaving the pMDI resin in second 28 and core 26 or if one is starting from a panel with PF in both surface layer 12 and 28 Applicant replaces the PF in the second layer 28 with pMDI and employs pMDI in the core to produce consolidated panels 10 that meet all commercial requirements yet are produced at significantly less costs. In both the above cases the panel 10 is formed with the first or smooth layer 12 incorporating phenolic resin and the second or rough layer 28 incorporates pMDI.

Thus the preferred panel 10 will consist of a core 26 and a second or rough surface layer 28 incorporating pMDI resin and the first or smooth surface layer 12 that incorporates a phenolic resin.

The preferred phenolic resin is phenol formaldehyde (PF) and will be present in the amount of 1.5 to 6% by weight of the strands in the first or smooth layer.

Melamine urea phenol formaldehyde (muPF) resin is also satisfactory to use in carrying out the present invention, however this resin though it does have some superior qualities is significantly more expensive than many other phenolic resins and thus is preferred to be used in combination with other phenolic resins particularly phenol formaldehyde. For example the MUF resin may be substituted for up to 50% of the phenol formaldehyde resin and the combination of resins applied in the amount of between 1.5 to 6% by weight of said strands. If 100% muPF resin is used the amount of resin in the first layer 12 could be as high as 12% by weight of said strands.

The amount of polymeric methylene diphenyl diisocyanate (pMDI) resin present in each of the core 26 and second or rough layer 28 layer is in the range of between 1.2 to 6% based on the weight of said strands in core 26 and second layer 28 respectively.

As indicated the reduction in release agent requirements obtained using this invention provides a very significant cost advantage over the use of pMDI in the first layer 12 and in the other scenario that used phenolic resin in both surface layers i.e. the first and second layers 12 and 28 and replacing the phenolic resin in the second surface layer 28 with pMDI also provides savings in that the cost of resin is reduced.

Standard rain tests were conducted on 7/16 inch thickness panels constructed using the present invention as were conventional panels currently being marketed to determine the stability or warping properties of the present invention relative to those of the prior art panels. The results are shown in Table 1.

TABLE 1

| | First layer | Second layer | Core | Press | |
|---|---|---|---|---|---|
| Test | Resin | Resin | Resin | Time (sec)./ | Warpage |
| No. | Type/% | Type/% | Type/% | Temp (° C.) | mm |
| 1 | PF/2.4 | PF/2.4 | pMDI/1.8 | 22/225 | 3 |
| 2 | PF/2.4 | PF/2.4 | pMDI/1.8 | 17/215 | 7.3 |
| 3 | PF/2.8 | pMDI/1.4 | pMDI/1.8 | 22/225 | 5 |
| 4 | PF/2.4 | pMDI/1.6 | pMDI/1.8 | 17/215 | 5 |

As can be seen from Table I the amount of warpage for a panel incorporating the present invention when subjected to a standard rain induced warpage was determined and is reported. Test on panels having the indicated resin in each layer 12 or 28 and the amounts defined (core 26 in all cases the resin used was pMDI in amount of 1.8%) and each panel was formed in a press using the normal pressure used to form panels between about 600 and 700 psi for the times and at the temperatures indicated. All the panels met the industries warp requirements and provide commercially acceptable panels. Test 1 and 2 show the effect of reducing press time and temperature with PF resin in the two surface layers and as can be seen that all tests show statistically similar amounts of warp and all are in an acceptable range.

The amount of Thickness swell and water absorption were also measured and the results are shown in Table 2.

TABLE 2

| | | Second | | |
|---|---|---|---|---|
| Sample/ | First Layer (12) | Layer (28) | Thickness | Water |
| Thickness | %/Resin | %/Resin | Swell % | Absorption % |
| 1./7/16 Inch | 2.4%/PF | 2.4%/PF | 28% | 61% |
| 2./7/16 Inch | 2.4%/PF | 1.6%/pMDI | 27% | 53% |
| 3./23/32 Inch | 3%/PF | 3%/PF | 12% | 35% |
| 4./23/32 Inch | 3%/PF | 1.8%/pMDI | 11% | 28% |

Test 1 and 2 show the effect of reducing press time and temperature with PF resin in the two surface layers and as can be seen that all tests show statistically similar amounts of warp and all are in an acceptable range.

As is clearly evident from Table 2 the Thickness swell and Water absorption characteristics are primarily governed by the amount of resin in the panel and that the substitution of pMDI for PF resin improves both properties (reduces). As can be seen from table 2 replacing the PF in the second layer (rough layer 28) with a lower % of pMDI added obtained the same or slightly better Thickness swell or Water Absorption in the panels (compare samples 1 and 2 and samples 3 and 4).

The tests reported in the above tables are based on small sample sized panels so more important to determining the effectiveness of the present invention is what was observed during a 2.5 day mill trial producing panels with the layer on one side (12) containing PF resin and the second layer (opposite side (28)) containing pMDI as did the core and confirmed the effectiveness of the present invention. In particular the absence of panel warp with the product produced. In this trial the large master panels made in accordance with the present invention would have warped on their way out of the press, and would have caused problems at the saws, this was not the case and provided a clear indication that the invention was a success.

Further results from these tests showed that:
Thickness swell (TS) is not statistically different between the all the panels even with 33% lower resin loading for the pMDI bottom surface layer (layer 28)
Thickness Swell by layer test shows top and bottom layers are in balance on control (2.4 PF first and second layer) and the invention with 2.4% PF and 1.6% pMDI. The recipe is 2.4 and 1.6D4 (a standard performance test of bond durability) of panels made using the present invention is consistently better than all PF surface control panels, on average 30% better.
23/32″ panel testing generated conclusions similar to that of 7/16″ panel.

Having described the invention, modifications will be evident to those skilled in the art without departing from the scope of the invention as defined in the appended claims.

What is claimed is:

1. A method of forming an oriented strand board (OSB) panel, the method comprising:
providing a lay-up having a first surface layer, a second surface layer and a core between the first surface layer and the second surface layer, wherein the first surface layer comprises wood strands with a binding resin that comprises phenolic resin without comprising any polymeric methylene diphenyl diisocyanate (pMDI) resin and the second surface layer is comprising wood strands with a binding resin that comprises pMDI resin without comprising any phenolic resin;
locating the lay-up in a press that includes a first platen facing the first surface layer and a second platen facing the second surface layer, wherein the first surface layer contacts the first platen and the second surface layer contacts a screen; and
pressing and consolidating the lay-up to form a consolidated panel having a smooth outer surface of the first surface layer and a rough outer surface of the second surface layer, wherein the pressing and consolidating is performed without a release agent.

2. The method of claim 1, wherein the phenolic resin is a phenol formaldehyde resin and is present in the amount of 1.5 to 6% by weight of the wood strands in the first surface layer.

3. The method of claim 1, wherein the phenolic resin is melamine urea phenol formaldehyde (muPF) resin.

4. The method of claim 1, wherein the phenolic resin includes up to 50% melamine urea phenol formaldehyde (muPF) resin based the weight of the phenolic resin with the remainder of the phenolic resin being phenol formaldehyde and the phenolic resin is present in the amount of 1.5 to 6% by weight of the wood strands.

5. The method of claim 1, wherein the pMDI resin is present in the second surface layer the range of between 1.2 to 6% based on the weight of the wood strands in the second surface layer.

6. The method of claim 1, wherein the first surface layer comprises 15-70 percent of the total weight of the panel and the second surface layer comprises 15-70 percent of the total weight of the panel.

7. A method of forming an oriented strand board (OSB) panel, the method comprising:
providing a lay-up having a first surface layer, a second surface layer and a core between the first surface layer and the second surface layer, wherein the first surface layer comprises wood strands with a binding resin that comprises between 2.4 and 2.8% phenol formaldehyde without comprising any polymeric methylene diphenyl diisocyanate (pMDI) resin and the second surface layer is comprising wood strands with a binding resin that comprises between 1.4 and 1.6% pMDI resin without comprising any phenol formaldehyde;
locating the lay-up in a press that includes a first platen facing the first surface layer and a second platen facing the second surface layer, wherein the first surface layer contacts the first platen and the second surface layer contacts a screen; and
forming the OSB panel by pressing and consolidating the lay-up at a pressure between about 600 and 700 psi, at a temperature between about 215 and 225° C., and for a time between about 17 and 22 seconds to form a consolidated panel having a smooth outer surface of the first surface layer and a rough outer surface of the second surface layer, wherein the pressing and consolidating is performed without a release agent.

8. The method of claim 7, wherein after the pressing and consolidating, the OSB panel has a warpage of no more than 5 mm.

9. The method of claim 7, wherein the first surface layer comprises 15-70 percent of the total weight of the panel and the second surface layer comprises 15-70 percent of the total weight of the panel.

10. The method of claim 7, wherein the core comprises about 1.8% pMDI.

11. The method of claim 7, wherein the OSB panel has a thickness of 7/16 inch.

12. The method of claim 7, wherein the OSB panel has a thickness of 23/32 inch.

13. A method of forming an oriented strand board (OSB) panel, the method comprising:
providing a core layer having opposite first and second surfaces, the core layer comprising of wood strands and a binding resin that comprises polymeric methylene diphenyl diisocyanate (pMDI) resin;
forming a first layer having a first surface facing the first surface of the core layer and an opposite second surface that provides a smooth outer surface, the first layer comprising wood strands and a binding resin that comprises phenolic resin without comprising any pMDI resin;
forming a second layer having a first surface facing the second surface of the core layer so that the core layer is between the first layer and the second layer, the second layer also having an opposite second surface that provides a rough surface, the second layer comprising wood strands and a binding resin that comprises pMDI resin without comprising any phenolic resin;
forming the OSB panel by pressing the core layer, the first layer, and the second layer, wherein the OSB panel has a warpage of no more than 5 mm.

14. The method of claim 13, wherein forming the OSB panel comprises locating the core layer, the first layer, and the second layer a press that includes a first platen facing the second surface of the first layer and a second platen facing the second surface of the second layer, wherein the second surface of the first layer contacts the first platen and the second surface of the second layer contacts a screen.

15. The method of claim 13, wherein forming the OSB panel further comprises by pressing the core layer, the first layer, and the second layer at a pressure between about 600 and 700 psi, at a temperature between about 215 and 225° C., and for a time between about 17 and 22 seconds without a release agent.

16. The OSB panel of claim 13, wherein the phenolic resin is a phenol formaldehyde resin and is present in the amount of 1.5 to 6% by weight of the wood strands in the first layer.

17. The OSB panel of claim 16, wherein the phenolic resin is melamine urea phenol formaldehyde (muPF) resin and wherein the pMDI resin is present in the second layer the range of between 1.2 to 6% based on the weight of the wood strands in the second layer.

18. The OSB panel of claim 16, wherein the phenolic resin includes up to 50% melamine urea phenol formaldehyde (muPF) resin based the weight of the phenolic resin with the remainder of the phenolic resin being phenol formaldehyde and the phenolic resin is present in the amount of 1.5 to 6% by weight of the wood strands.

19. The OSB panel of claim 13, wherein the first layer comprises 15-70 percent of the total weight of the panel and the second layer comprises 15-70 percent of the total weight of the panel.
